(19) United States
(12) Patent Application Publication
(10) Pub. No.: US 2025/0365109 A1
(43) Pub. Date: Nov. 27, 2025

(54) METHODS, DEVICES, AND SYSTEMS FOR DETERMINING STATISTICAL INFORMATION

(71) Applicant: ZTE Corporation, Shenzhen (CN)

(72) Inventors: Jing SHI, Shenzhen (CN); Xianghui Han, Shenzhen (CN); Shuaihua Kou, Shenzhen (CN); Wei Gou, Shenzhen (CN)

(73) Assignee: ZTE Corporation, Shenzhen (CN)

(21) Appl. No.: 19/294,732

(22) Filed: Aug. 8, 2025

Related U.S. Application Data
(63) Continuation of application No. PCT/CN2023/087113, filed on Apr. 7, 2023.

(51) Int. Cl. H04L 5/00; H04L 5/14

(52) U.S. Cl. CPC H04L 5/0044; H04L 5/14

(57) ABSTRACT

The present disclosure describes methods, system, and devices for determining statistical information. The method includes reporting, by a user equipment (UE), a duration to a base station, wherein: the reported duration indicates, to the base station, at least one of an evaluation duration, a fallback duration and a starting time, and the fallback duration corresponds to a fallback power class applied that is a lower transmission power than a declared or supported power class. The method may further include determining, by the UE, whether a duty cycle during the evaluation duration is larger than a maximum duty cycle, and in response to determining that the duty cycle is larger, sending, by the UE, uplink transmission with the fallback power class, wherein the fallback power class comprises one of a reduced power class and a default power class.

### TECHNICAL FIELD

The present disclosure is directed generally to wireless communications. Particularly, the present disclosure relates to methods, devices, and systems for determining statistical information.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In wireless communication system, a user equipment (UE) may have capability to support one or more different power class than the default UE power class for the band and the supported power class enables the higher maximum output power than that of the default power class. When a percentage of uplink symbols transmitted in a certain evaluation period (e.g., duty cycle) is larger than a threshold (e.g., maximum duty cycle), the UE may apply all requirements for the default power class to the supported power class. There are various issues/problems associated with this implementation. For example, one issue/problem may be that, while the evaluation period is no less than one radio frame, a base station may not know the exact evaluation period that the UE used and also not know the duration of default power class applied, which may lead to some ambiguity issue for uplink power control. Another issue/problem may include that, in case non-overlapped sub-band full duplex is applied wherein a uplink sub-band is introduced in downlink or flexible symbols, it is uncertain how to calculate the percentage of uplink symbols transmitted in a certain evaluation period.

The present disclosure describes various embodiments for determining statistical information, addressing at least one of the issues/problems discussed in the present disclosure.

### SUMMARY

This document relates to methods, systems, and devices for wireless communication, and more specifically, for determining statistical information. The various embodiments in the present disclosure may include new method for determining statistical information, which is beneficial to enhance efficient utilization of a power class of the UE, improve a base station's scheduling decisions, increase the resource utilization efficiency, and/or boost performance of the wireless communication.

In one embodiment, the present disclosure describes a method for wireless communication. The method includes reporting, by a user equipment (UE), a duration to a base station, wherein: the reported duration indicates, to the base station, at least one of an evaluation duration, a fallback duration and a starting time, and the fallback duration corresponds to a fallback power class applied that is a lower transmission power than a declared or supported power class. The method may further include determining, by the UE, whether a duty cycle during the evaluation duration is larger than a maximum duty cycle, and in response to determining that the duty cycle during the evaluation duration is larger than the maximum duty cycle, sending, by the UE, uplink transmission with the fallback power class, wherein the fallback power class comprises one of a reduced power class and a default power class. The duty cycle means the percentage of uplink symbols transmitted in a certain evaluation period.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a schematic diagram of an exemplary embodiment for wireless communication.

FIG. 5B shows a schematic diagram of another exemplary embodiment for wireless communication.

FIG. 5C shows a schematic diagram of another exemplary embodiment for wireless communication.

FIG. 6A shows a schematic diagram of another exemplary embodiment for wireless communication.

FIG. 6B shows a schematic diagram of another exemplary embodiment for wireless communication.

FIG. 7A shows a schematic diagram of another exemplary embodiment for wireless communication.

FIG. 7B shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for determining statistical information.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC). In some implementations, coverage enhancement may be a requirement for 4G, 5G, and/or further generation communication system.

In wireless communication system, a user equipment (UE) may have capability to support one or more different power class than the default UE power class for the band and the supported power class enables the higher maximum output power than that of the default power class. When a percentage of uplink symbols transmitted in a certain evaluation period (e.g., duty cycle) is larger than a threshold (e.g., maximum duty cycle), the UE may apply all requirements for the default power class to the supported power class. There are various issues/problems associated with this implementation. For example, one issue/problem may be that, while the evaluation period is no less than one radio frame, a base station (or a wireless communication node) may not know the exact evaluation period that the UE used and also not know the duration of default power class applied, which may lead to some ambiguity issue for uplink power control. Another issue/problem may include that, in case non-overlapped sub-band full duplex is applied wherein a uplink sub-band is introduced in downlink or flexible symbols, it is uncertain how to calculate the percentage of uplink symbols transmitted in a certain evaluation period.

The present disclosure describes various embodiments for determining statistical information, addressing at least one of the issues/problems discussed in the present disclosure.

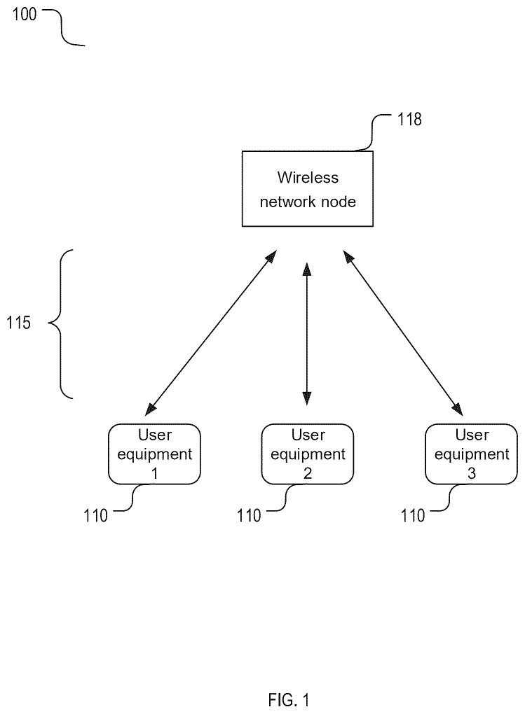

FIG. 1 shows a wireless communication system 100 including a wireless network node (or a wireless communication node) 118 and one or more user equipment (UE) (or a wireless communication device) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

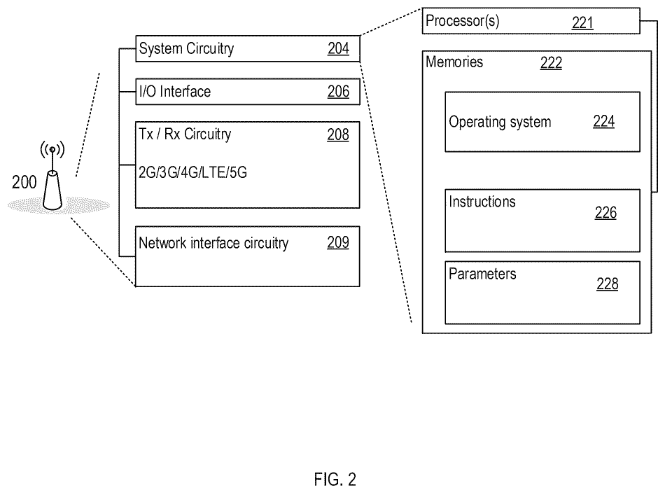

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

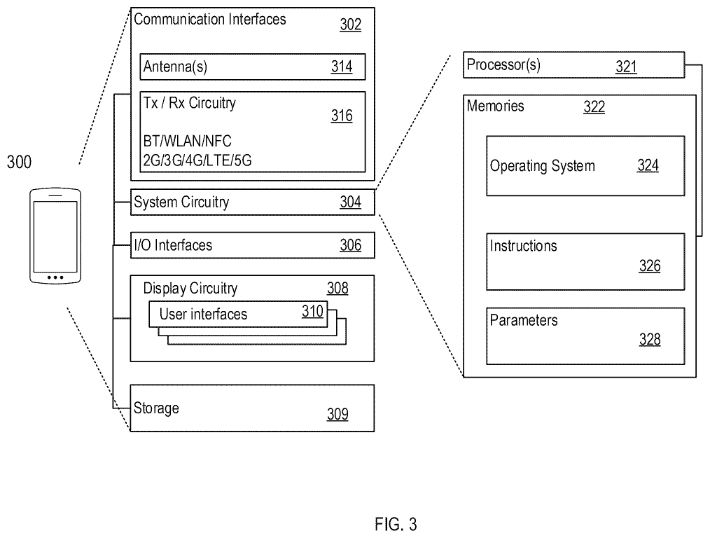

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for determining statistical information, which may be implemented, partly or totally, on the network base station and/or the user equipment described above in FIGS. 2-3. The various embodiments in the present disclosure may enable efficient wireless transmission in the telecommunication system, which may increase the resource utilization efficiency and/or boost latency performance of URLLC traffic.

In some implementations of a wireless communication system, for a single uplink (UL) carrier, a UE may be allowed to set its configured maximum output power P_{CMAX,f,c} for a carrier f of a serving cell c. The configured maximum output power P_{CMAX,f,c} may be set within the following bounds: P_{CMAX_L,f,c}≤P_{CMAX,f,c}≤P_{CMAX_H,f,c}, wherein P_{CMAX_L,f,c} and P_{CMAX_H,f,c} are depended on P_{PowerClass}, and P_{PowerClass,c} is the linear value of the maximum UE power for serving cell c or ue-PowerClass without taking into account the tolerance.

In some implementations of a wireless communication system, for a uplink (UL) carrier aggregation (CA), a UE may be allowed to set its configured maximum output power P_{CMAX,c} for a serving cell c and its total configured maximum output power P_{CMAX}. The total configured maximum output power P_{CMAX} may be set within the following bounds: P_{CMAX_L}≤P_{CMAX}≤P_{CMAX_H}, wherein P_{CMAX_L} and P_{CMAX_H} are depended on P_{PowerClass,CA}. The maximum power class (PC) of the P_{PowerClass,CA} may be PC2, which the power can be used in UL CA is restricted by the P_{PowerClass,CA}. In some case, P_{PowerClass,CA} is replaced by 10 log₁₀Σp_{PowerClass,c} which is also named as the aggregated power in UL CA, wherein P_{PowerClass,c} is the linear value of the maximum UE power for serving cell c or ue-PowerClass without taking into account the tolerance.

In some implementations, a power headroom (PHR) calculation may be performed as following.

$${PH}_{type 1 b , f , c} ( i , j , {q}_{d} , l ) = {P}_{CMAX , f , c} ( i ) - \{ {P}_{O\_PUSCH , b , f c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

Wherein, P_{CMAX,f,c}(i) is the UE configured maximum output power for a carrier f of a serving cell c in PUSCH transmission occasion i. {P_{O_PUSCH,b,f,c}(j)+α_{b,f,c}(j)*PL_{b,f,c}(q_{d})} are related to open loop power control parameters, wherein P_{O_PUSCH,b,f,c}(j)=P_{O_NOMINAL,PUSCH,f,c}(j) (cell-specific)+P_{O_UE_PUSCH,b,f,c}(j) (UE-specific), {P_{O_UE_PUSCH,b,f,c}(j), α_{b,f,c}(j)} is determined by P0-PUSCH-AlphaSet and SRI indication; PL_{b,f,c}(q_{d}), is a downlink pathloss estimate in dB calculated by the UE using reference signal (RS) index q_{d} for the active DL BWP of carrier f of serving cell c.

Wherein, f_{b,f,c}(i, l) is related to closed loop power control parameter. For the PUSCH power control adjustment state f_{b,f,c}(i, l) for active UL BWP b of carrier f of serving cell c in PUSCH transmission occasion i. l∈{0,1}.

$${f}_{b , f , c} ( i , l ) = {f}_{b , f , c} ( i - {i}_{0} , l ) + {\sum }_{m = 0}^{𝒞 ( {D}_{i} ) - 1} {δ}_{PUSCH , b , f , c} ( m , l ) ,$$

wherein δ_{PUSCH,b,f,c}(i,l) is a transmission power control (TPC) command value included in a DCI format 0_0 or DCI format 0_1 that schedules the PUSCH transmission occasion i on active UL BWP b of carrier f of serving cell c.

Wherein,

$${M}_{RB , b , f , c}^{PUSCH} ( i )$$

is the bandwidth of the PUSCH resource assignment expressed in number of resource blocks for PUSCH transmission occasion i on active UL BWP b of carrier f of serving cell c and μ is a SCS configuration. It is a resource block (RB) number for PUSCH, reflecting bandwidth impact on Tx power.

$${Δ}_{TF , b , f , c} ( i ) = 10 {log}_{10} ( ( {2}^{BPRE - {K}_{s}} - 1 ) \cdot {β}_{offset}^{PUSCH} ) for {K}_{S} = 1.25 and {Δ}_{TF , b , f c} ( i ) = 0 for {K}_{S} = 0$$

where K_{S} is provided by deltaMCS for each UL BWP b of each carrier f of serving cell c. It is a bits per resource element (BPRE) function, reflecting modulation and coding scheme (MCS) impact on transmission power.

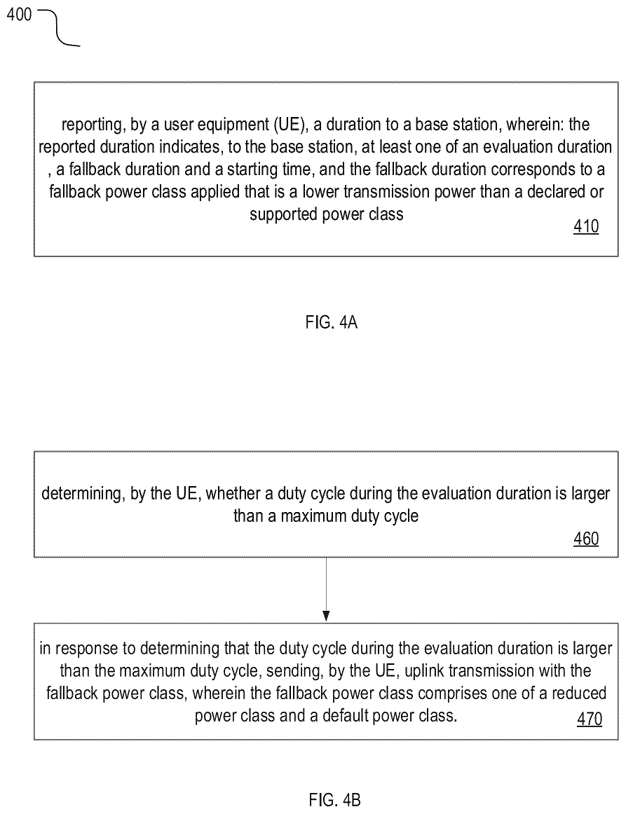

Referring to FIG. 4A, the present disclosure describes various embodiments of a method 400 for wireless communication. The method 400 may be performed by a wireless communication device (e.g., a user equipment). The method 400 may include step 410, reporting, by a user equipment (UE), a duration to a base station, wherein: the reported duration indicates, to the base station, at least one of an evaluation duration, a fallback duration and a starting time, and the fallback duration corresponds to a fallback power class applied that is a lower transmission power than a declared or supported power class.

Referring to FIG. 4B, the method 400 may further include a portion or all of the following steps: step 460, determining, by the UE, whether a duty cycle during the evaluation duration is larger than a maximum duty cycle, and/or step 470, in response to determining that the duty cycle during the evaluation duration is larger than the maximum duty cycle, sending, by the UE, uplink transmission with the fallback power class, wherein the fallback power class comprises one of a reduced power class and a default power class.

In various embodiments in the present disclosure, the duty cycle means the percentage of uplink symbols transmitted in a certain evaluation period.

In some implementations, the reported duration indicates, to the base station, the evaluation duration and the fallback duration; and/or a starting time of the fallback duration is a first symbol in a next duration after the evaluation duration.

In some implementations, the reported duration indicates, to the base station, the fallback duration; and/or a starting time of the fallback duration is a first symbol in the reported duration, or is reported by at least one of an index of a radio frame and an index of a slot.

In some implementations, the UE sends a power headroom report (PHR) to the base station, and the PHR comprises the reported duration indicating the fallback duration.

In some implementations, a starting time of the fallback duration is determined by one of following: the PHR comprises a starting time of the fallback duration indicated by at least one of an index of a radio frame and an index of a slot; and/or the starting time of the fallback duration is determined by a time point of the PHR; and/or in response to the PHR being re-transmitted, the starting time of the fallback duration is determined by an initial transmission of the PHR.

In some implementations, the UE sends a power headroom report (PHR) to the base station, and the PHR comprises the reported duration indicating a total duration comprising the evaluation duration and the fallback duration.

In some implementations, in response to a sub-band full duplex (SBFD) operation, the UE determines the duty cycle during the evaluation duration as a percentage of transmitted uplink symbols and transmitted uplink SBFD symbols, or symbols for UL transmitted during the evaluation period.

In some implementations, in response to a SBFD operation, the UE determines the duty cycle during the evaluation duration based on double-counting SBFD symbols for calculating total symbols within the sub-band.

In some implementations, in response to a SBFD operation, the UE determines the duty cycle during the evaluation duration based on excluding SBFD symbols for the duty within the sub-band.

In some implementations, in response to a SBFD operation in a sub-band, the UE determines the duty cycle during the evaluation duration based on counting all SBFD symbols as uplink for the duty within the sub-band.

In some implementations, in response to a SBFD operation, the UE determines the duty cycle during the evaluation duration based on regarding an original band and the sub-band as two separate bands by: averaging percentages of uplink symbols of the sub-band and the original band.

In some implementations, in response to a SBFD operation in a sub-band, the UE determines the duty cycle during the evaluation duration based on regarding an original band and the sub-band as two separate bands by: weight averaging percentages of uplink symbols of the sub-band with a first weight and the original band with a second weight, wherein the sum of the two weight is 1.

In some implementations, the first weight is the SBFD symbols divided by a summation of the SBFD symbols and all symbols, and the second weight is one subtracted by the first weight; or the first weight is the SBFD symbols divided by all symbols, and the second weight is one subtracted by the first weight.

In some implementations, in response to a SBFD operation in a sub-band, the UE determines the duty cycle during the evaluation duration based on a first evaluation sub-duration for the SBFD symbols and a second evaluation sub-duration for other symbols by: adding a first percentage of uplink SBFD symbols during the first evaluation sub-duration and a second percentage of other uplink symbols during the second evaluation sub-duration.

In some implementations, the method may further include averaging the first percentage of the uplink SBFD symbols during the first evaluation sub-duration and the second percentage of the other uplink symbols during the second evaluation sub-duration, or weight averaging the first percentage of the uplink SBFD symbols during the first evaluation sub-duration and the second percentage of the other uplink symbols during the second evaluation sub-duration.

In some implementations, in response to a SBFD operation in a sub-band, the UE determines the duty cycle during the evaluation duration based on the evaluation duration for all symbols and an evaluation sub-duration for the SBFD symbols by: adding a first percentage of uplink SBFD symbols during the evaluation sub-duration and a second percentage of other uplink symbols during the evaluation duration.

In some implementations, the method further include averaging the first percentage of uplink SBFD symbols during the evaluation sub-duration and the second percentage of the other uplink symbols during the evaluation duration, or weight averaging the first percentage of uplink SBFD symbols during the evaluation sub-duration and the second percentage of the other uplink symbols during the evaluation duration.

In some implementations, the SBFD symbols are double-counted or excluded or counted as all uplink for the sub-band.

### Embodiment Set I

The present disclosure describes various embodiments for determining statistical information, wherein a timeline of power reduction or power recover is described. Various methods may include reporting/configuring one duration/period to determine the at least one of evaluation period and the duration for applying the reduced/default power class when the duty cycle is larger than a duty cycle threshold (e.g., a maximum duty cycle). In some implementations, one duration/period is equal to evaluation period and the duration for applying the reduced/default power class. In some implementations, one duration/period is only for the duration for applying the reduced/default power class.

In some implementations, a current scheme is to apply ‘default power class’ when percentage of UL symbols larger than the duty cycle, or to apply ‘supported power class’ when percentage of UL symbols not larger than the duty cycle. There is no any timeline restricted/defined for applying the reduced power or recovering the supported power.

In some implementations, in order to resolve the exact evaluation period and the duration of reduced or default power class applied are not known for gNB, timeline of power reduction or power recover is introduced.

In some implementations, one duration/period is reported/configured to determine the at least one of evaluation period and the duration for applying the reduced/default power class when a duty cycle is larger than a maximum duty cycle (e.g., 50%).

For one method (Alternative 1), one duration/period is equal to evaluation period and the duration for applying the reduced/default power class. The start time to apply ‘reduced/default power class’ is the first symbol in the next period when the duty cycle in a evaluation period is larger than the maximum duty cycle. In some implementations, value of period is one radio frame, a plurality of radio frames, or multiple of two radio frames. For example, in case of multiple of two radio frames, potential start time is the first symbol of the even frame and duration/period is two radio frames.

For another method (Alternative 2), one duration/period is only for the duration for applying the reduced/default power class. That is, regardless of the value of the evaluation period, the starting time to apply ‘reduced/default power class’ is the first symbol in a period.

In some implementations, value of duration is two radio frames. For example, potential starting time is the first symbol of each even frame, regardless evaluation period is one or multiple radio frames.

In some implementations, in case the evaluation period is

defined/configured/reported, the starting time can be the first symbol in next evaluation period and optional combined with an offset, and the duration can be configured or a factor a x (evaluation period), i.e. α=0.5, 1, 2, etc.

Various embodiments described in the present disclosure may have the following benefits: at least one of evaluation period and the duration for applying the reduced or default power class can be configured or reported; and/or at least the duration for applying the reduced or default power class can be known for both gNB and UE. Therefore, it is benefit for achive higher efficient utilization of the maximum power of the UE to improve gNB scheduling decisions.

### Embodiment Set II

The present disclosure describes various embodiments for determining statistical information, wherein power headroom reporting (PHR) enhancement is described. In some implementations, various methods may include only reporting a duration applied of fallback/default/reduced power class (PC) or the ΔP_{PowerClass} report. In some implementations, various method may include only reporting a total duration/period comprising evaluation period and duration applied PC fallback. Optionally, the ΔP_{PowerClass} may be also reported with smaller granularity, such as 1, 2, 3, or 4 dB. Optionally, the PC may be also reported, such as 20, 23, 26, or 29 dBm.

In some implementations, at least one of evaluation period and the duration for applying the reduced/default power class or the total duration comprising evaluation period and the duration for applying the reduced/default power class are reported combined with the PHR reporting. That is to report some additional information to a gNB for more efficient power control.

In some implementations, a Maximum Permissible Exposure (MPE) field may be used for frequency range 2 (FR2), and may be reused for frequency range 1 (FR1). The further consideration is to reinterpret MPE in FR2 to PC or ΔP_{PowerClass} or duration/period in FR1, etc. For example, in case of reinterpret MPE to PC, PC3, PC2, PC1.5, PC1 can be the candidate values.

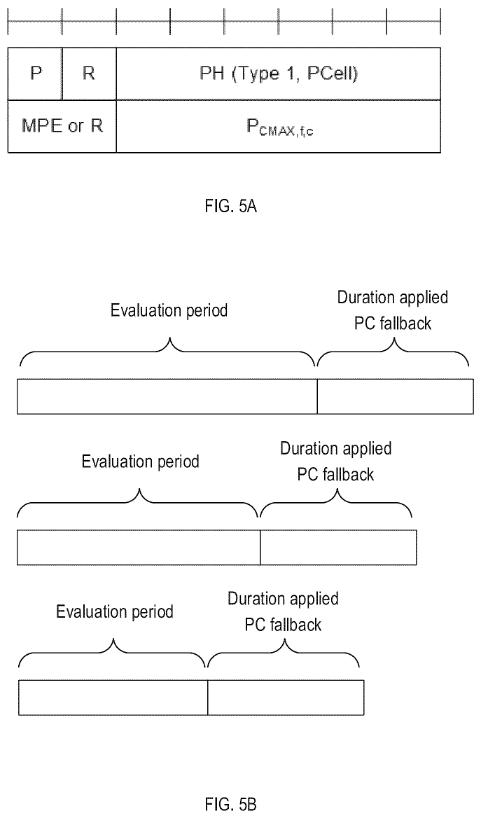

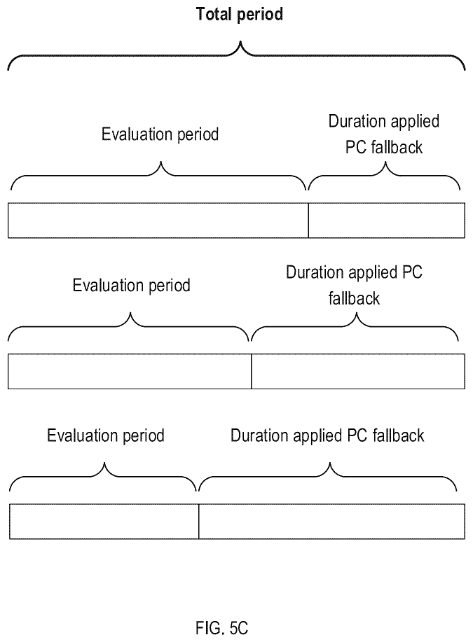

In some implementations referring to FIG. 5A, for a MPE field, when mpe-Reporting-FR2 is configured, and the Serving Cell operates on FR2, and when the P field is set to 1, this field indicates the applied power backoff to meet MPE requirements. This field indicates an index to Table 1 and the corresponding measured values of P-MPR levels in dB may be specified. The length of the field is 2 bits. If mpe-Reporting-FR2 is not configured, or if the Serving Cell operates on FR1, or if the P field is set to 0, R bits are present instead. FIG. 5A shows single entry PHR medium access control (MAC) control element (CE).

The R field is a reserved bit, and may be set to 0;

For a power headroom (PH) field, this field indicates the power headroom level. The length of the field is 6 bits. The reported PH and the corresponding power headroom levels are be specified, and the corresponding measured values in dB may be specified.

For P field, when mpe-Reporting-FR2 is configured and the Serving Cell operates on FR2, the MAC entity shall set this field to 0 if the applied P-MPR value, to meet MPE requirements, is less than P-MPR_00 as specified; and to 1 otherwise. When mpe-Reporting-FR2 is not configured or the Serving Cell operates on FRI, this field indicates whether power backoff is applied due to power management (as allowed by P-MPRc as specified). The MAC entity shall set the P field to 1 if the corresponding P_{CMAX,f,c} field would have had a different value if no power backoff due to power management had been applied.

For a P_{CMAX,f,c} field, this field indicates the P_{CMAX,f,c} used for calculation of the preceding PH field. The reported P_{CMAX,f,c} and the corresponding nominal UE transmit power levels are specified, and the corresponding measured values in dBm are specified.

TABLE 1
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

Various embodiments may include other schemes of PHR reporting enhancement, as described below.

One scheme (Scheme 1), referring to FIG. 5B, includes only reporting a duration applied of fallback/default/reduced power class or the ΔP_{PowerClass} report. Optionally the duration is same/fixed value. That is after the duration, return to declared power class and power class fallback when the duty cycle is larger than a duty cycle threshold. This scheme may provide the following benefits: for different UE vendor, the evaluation period could be different, while the duration applied the ΔP_{PowerClass} report is fixed/configured/reported/known for both gNB and UE; and/or the restriction that prevent triggering a PC fallback is not introduced. In some implementations, the duration information may be added to the PHR MAC CE.

In some implementations, the start time of the duration may be determined by one of following methods. For one method (Alternative 1), besides the duration is added to the PHR MAC CE, the start time is also added to the PHR MAC CE, e.g. the start time is indicated by a index of a radio frame and optionally with an index of a slot within the radio frame. For another method (Alternative 2), the start time is determined by a timing of the MAC CE being received. For another method (Alternative 3), when the PUSCH carrying the MAC CE is received by re-transmission, the start time is determined by the initial transmission of the PUSCH carrying the MAC CE.

Another scheme (Scheme 2), referring to FIG. 5C, include only reporting a total duration/period comprising evaluation period and duration applied PC fallback. This scheme can be a trade-off, that is only the start of evaluation and the end of fallback PC may be known to gNB, while the start of duration applied PC fallback can be variable. This scheme may provide the following benefits: at least partial issues of gNB may be resolved that the end of PC fallback applied can be known.

In some implementations, the start time of the period may be the first symbol of each period which is start from radio frame #0, or may be determined similar as in scheme 1.

Various embodiments described in the present disclosure may have the following benefits: at least one of evaluation period and the duration for applying the reduced or default power class may be configured or reported combined with PHR reporting; and/or at least the duration for applying the reduced or default power class may be known for both gNB and UE. It is benefit for achieving higher efficient utilization of the maximum power of the UE to improve gNB scheduling decisions.

### Embodiment Set III

The present disclosure describes various embodiments for determining statistical information, wherein, in case of a sub-band introduced for sub-band full duplex (SBFD) operation, determining duty cycle is described.

Various embodiments include calculating the duty cycle based on single band and regardless of DL/UL sub-band. In some implementations, for a single band, duty cycle is the percentage of uplink symbols transmitted and SBFD symbols with UL transmitted (the percentage of symbols for UL transmitted) in a certain evaluation period, wherein the exact evaluation period is no less than one radio frame. In some implementations, SBFD symbols within the same evaluation period may be double counted for the duty within the sub-band. In some implementations, SBFD symbols within the same evaluation period may not be counted for the duty within the sub-band. In some implementations, SBFD symbols within the same evaluation period may be counted as 100% for the duty calculation within the sub-band.

Various embodiments include calculating the duty cycle based on the sub-band level for duty cycle calculation. In some implementations, two (or three) sub-bands may be used to calculate the average percentage of uplink symbols, calculating average or weight average percentage of uplink symbols of UL sub-band and the original band.

Various embodiments include calculating the duty cycle based on two evaluation periods. In some implementations, within an evaluation period (i.e. at least one radio frame), two sub-period are divided: one is time duration of sub-band for SBFD symbols evaluation, and the rest is for legacy UL symbols transmitted evaluation.

In some implementations, the power class of UE is related to the time division duplex (TDD) duty cycle. When the duty cycle is changed by implementing SBFD, it may also impact the power class determination.

In some implementations, beside only time domain is considered, two bands in a Band Combination (BC) may also be considered. Under some circumstances, only the inter-band CA with two bands for UE maximum output power may be specified.

In some implementations, a duty cycle may be determined as the following. For a single band, duty cycle is the percentage of uplink symbols transmitted in a certain evaluation period (The exact evaluation period is no less than one radio frame). For inter-band CA (two bands), or SUL, duty cycle is average percentage of uplink symbols which is defined as 50%×(Duty_{NR, x}/maxDuty_{NR,x}+Duty_{NR, y}/maxDuty_{NR,y}). Duty_{NR, x}, Duty_{NR, y} represent the actual percentage of uplink symbols transmitted in the same evaluation period, wherein the exact evaluation period is no less than one radio frame, for NR Band x, NR Band y respectively. maxDuty_{NR,x}, maxDuty_{NR,y} represent the field of UE capability max UplinkDutyCycle-PC2-FR1 per band.

Various embodiments include various method for, in case sub-band introduced for SBFD operation, determining duty cycle.

For one scheme (Scheme 1), various methods include calculating the duty cycle based on single band and regardless of DL/UL sub-band by one of the following.

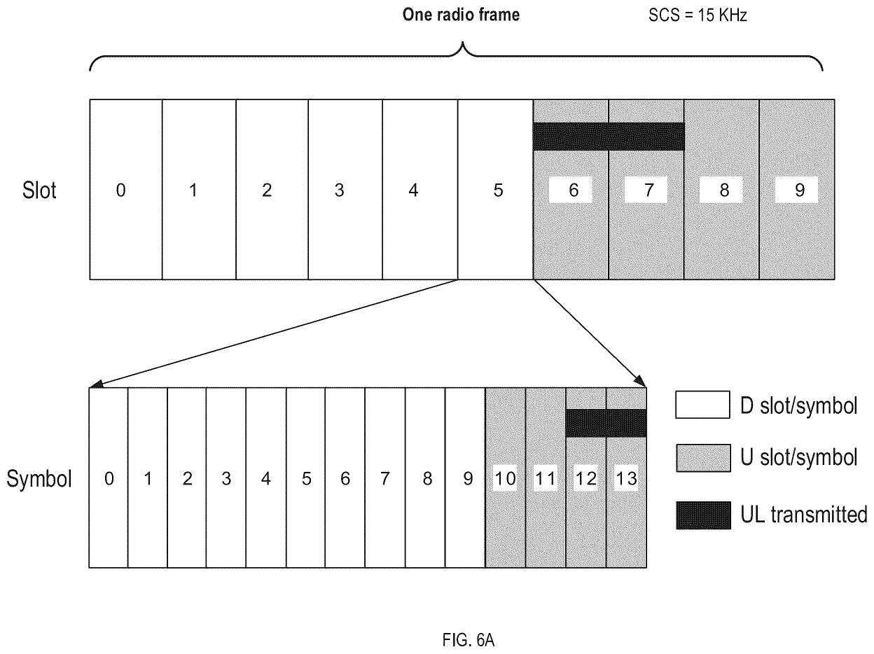

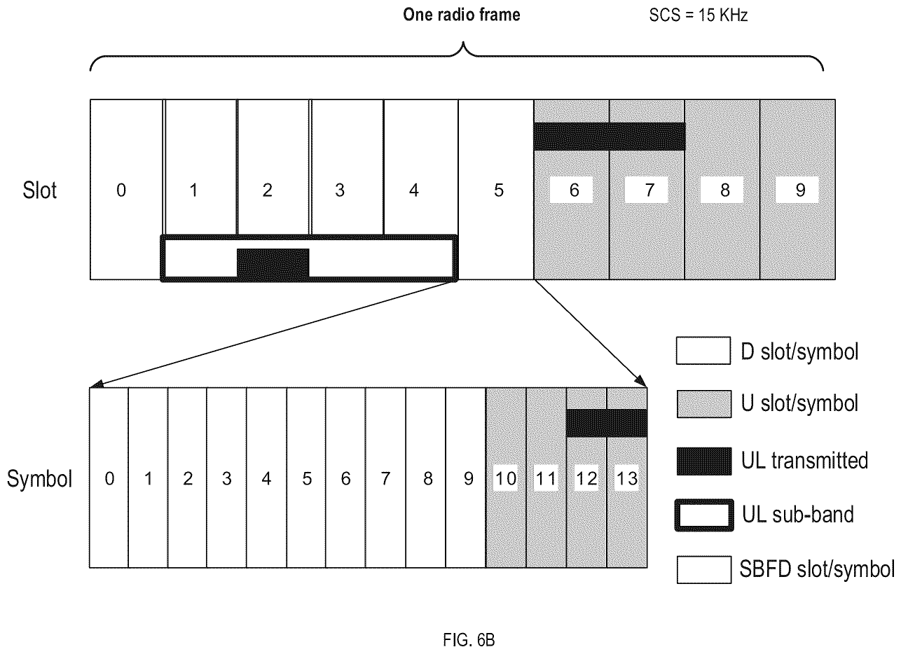

For one method (Alternative 1), for a single band, referring to FIG. 6A, duty cycle is the percentage of uplink symbols transmitted and SBFD symbols with UL transmitted in a certain evaluation period, wherein the exact evaluation period is no less than one radio frame. In other words, for a single band, duty cycle is the percentage of symbols for UL transmitted in a certain evaluation period. For a non-limiting example, in FIG. 6A, one radio frame includes 10 slots, and each slot may include 14 symbols; the sub-carrier spacing (SCS) may be 15 KHz; and the duty cycle is calculated as: Duty Cycle=(2+28)/140=21.43%.

For another non-limiting example, in FIG. 6B, the duty cycle is calculated as:

$$Duty Cycle = ( 14 + 2 + 28 ) / 140 = 0 \text{.1} + 0.2143 = 31.43 \% .$$

In some implementations, there may be downlink transmission also existed in the same SBFD symbols, and may not be aligned with the intention of duty cycle, i.e., both DL signal and UL signal are present at a time.

For another method (Alternative 2), SBFD symbols within the same evaluation period may be double counted for the duty within the sub-band. In another word, one SBFD symbol may be regarded as “two symbols” in evaluation, especially for the UE with capability of reception and transmission simultaneously. Optionally as “three symbols” for “DUD” structure. For a non-limiting example, in FIG. 6B, the duty cycle is calculated as: Duty Cycle=14/(56+140)+(2+28)/140=0.0714+0.2143=28.57%.

For another method (Alternative 3), SBFD symbols within the same evaluation period may be not counted for the duty within the sub-band. In another word, one SBFD symbol can be discarded in evaluation, especially for the UE with capability of reception and transmission simultaneously. For a non-limiting example, in FIG. 6B, the duty cycle is calculated as: Duty Cycle=(2+28)/140=21.43%.

For another method (Alternative 4), SBFD symbols within the same evaluation period may be counted as 100% for the duty calculation within the sub-band. In another word, one SBFD symbol may be regarded as ‘FDD’ band in evaluation, especially for the UE with capability of reception and transmission simultaneously. For a non-limiting example, in FIG. 6B, the duty cycle is calculated as: Duty Cycle=(56/140)*100%+(2+28)/140=0.4+0.2143=61.43%.

For another scheme (Scheme 2), various methods include calculating the duty cycle based on the sub-band level for duty cycle calculation. Two (or three) sub-bands may be used to calculate the average percentage of uplink symbols.

For one sub-scheme (Scheme 2-1), the duty cycle may be calculated based on average percentage of uplink symbols of UL sub-band and the original band.

For one method (Alternative 1), the duty cycle may be calculated as 50%×(Duty_{NR, x_subband}/maxDuty_{NR,x_subband}+Duty_{NR, x}/maxDuty_{NR,x,}), wherein, Duty_{NR, x}, Duty_{NR, x_subband} represent the actual percentage of uplink symbols transmitted and SBFD symbols with UL transmitted in the same evaluation period, wherein the exact evaluation period is no less than one radio frame, for the NR Band x and the sub-band in the NR Band x, respectively. The maxDuty_{NR,x_subband}, maxDuty_{NR,x} represent the field of UE capability maxUplinkDutyCycle-PC2-FR1per band; and in some implementations, maxDuty_{NR,x_subband} is equal to maxDuty_{NR,x}. In some other implementations, the maxDuty_{NR,x_subband} can be configured independently. For a non-limiting example, in FIG. 6B, when maxDuty_{NR,x_subband}=maxDuty_{NR,x}=50%. the duty cycle is calculated as: Duty Cycle=50%×(10%/50%+21.43%/50%)=31.43%

For another method (Alternative 2), the duty cycle may be calculated as 50%×(Duty_{NR, x_subband}/maxDuty_{NR,x_subband}+Duty_{NR, x}/maxDuty_{NR,x,}). Duty_{NR, x}, Duty_{NR, x_subband} represent the actual percentage of uplink symbols transmitted and SBFD symbols with UL transmitted in the same evaluation period, wherein the exact evaluation period is no less than one radio frame, for the NR Band x and the sub-band in the NR Band x, respectively. Further, the SBFD symbols within the same evaluation period may be double counted for Duty_{NR, x_subband}. maxDuty_{NR,x_subband}, maxDuty_{NR,x} represent the field of UE capability maxUplinkDutyCycle-PC2-FR1 per band. In some implementations, maxDuty_{NR,x_subband} is equal to maxDuty_{NR,x}. In some other implementations, the maxDuty_{NR,x_subband} may be configured independently. For a non-limiting example, in FIG. 6B, when maxDuty_{NR,x_subband}=maxDuty_{NR,x}=50%. the duty cycle is calculated as: Duty Cycle=50%×(7.14%/50%+21.43%/50%)=28.57%

For another sub-scheme (Scheme 2-2), the duty cycle may be calculated based on weight average percentage of uplink symbols of UL sub-band and the original band according to various methods as described below. The motivation is, the UL sub-band is located on partial slots/symbols, not a whole carrier in time domain. Optionally, the UL sub-band is located on partial PRBs of the BWP/carrier, not a whole BWP/carrier in frequency domain.

For one method (Alternative 1), the duty cycle may be calculated as P1×Duty_{NR, x_subband}/maxDuty_{NR,x_subband}+P2×Duty_{NR, x}/maxDuty_{NR,x}. Duty_{NR, x}, Duty_{NR, x_subband} represent the actual percentage of uplink symbols transmitted and SBFD symbols with UL transmitted in the same evaluation period, wherein the exact evaluation period is no less than one radio frame, for the NR Band x and the sub-band in the NR Band x, respectively. P1 is a first weight for weighed average, and is the number of (SBFD symbols)/(SBFD symbols+all symbols) within the evaluation period; P2 is a second weight for weighed average, and is the number of (all symbols)/(SBFD symbols+all symbols) within the evaluation period; maxDuty_{NR,x_subband}, maxDuty_{NR,x} represent the field of UE capability maxUplinkDutyCycle-PC2-FR1 per band, and maxDuty_{NR,x_subband} is equal to maxDuty_{NR,x}. In some implementations, the maxDuty_{NR,x_subband} can be configured independently. For a non-limiting example, in FIG. 6B, when maxDuty_{NR,x_subband}=maxDuty_{NR,x}=50%. the duty cycle is calculated as: Duty Cycle=4/14×(10%/50%)+10/14× 21.43%/50%=0.0571+0.3061=36.32%.

For another method (Alternative 2), the duty cycle may be calculated as P1×Duty_{NR, x_subband}/maxDuty_{NR,x_subband}+P2×Duty_{NR, x}/maxDuty_{NR,x}. Duty_{NR, x}, Duty_{NR, x_subband} represent the actual percentage of uplink symbols transmitted and SBFD symbols with UL transmitted in the same evaluation period, wherein the exact evaluation period is no less than one radio frame, for the NR Band x and the sub-band in the NR Band x, respectively. In some implementations, P1 is a first weight for weighed average, and is the number of (SBFD symbols)/(all symbols) within the evaluation period. In some implementations, P2 is a second weight for weighed average, and P2=1−P1; or is the number of (non-SBFD symbols)/(all symbols) within the evaluation period. maxDuty_{NR,x_subband}, maxDuty_{NR,x} represent the field of UE capability maxUplinkDutyCycle-PC2-FR1 per band, and maxDuty_{NR,x_subband} is equal to maxDuty_{NR,x}. In some implementations, the maxDuty_{NR,x_subband} can be configured independently. In some implementations, P1/P2 can be determined by the percentage of frequency of UL subband and the original frequency of the BWP/carrier/band. For example, P1=(PRB of subband)/(PRB of UL carrier), and P2=1−P1. For a non-limiting example, in FIG. 6B, when maxDuty_{NR,x_subband}=maxDuty_{NR,x}=50%. the duty cycle is calculated as: Duty Cycle=4/10×(10%/50%)+6/10×21.43%/50%=0.08+0.25716=33.72%.

For another method (Alternative 3), P1 and P2 can be determined by the percentage of frequency of UL subband and the original frequency of the BWP/carrier/band. For example, P1=(PRB of subband)/(PRB of UL carrier), and P2=1−P1.

For another method (Alternative 4), P1 and P2 can be determined by the percentage of frequency of UL subband and the original frequency of the BWP/carrier/band. For example, P1=(PRB of subband)/(PRB of subband+PRB of UL carrier), and P2=1−P1.

For another method (Alternative 5), the duty cycle may be calculated as P1×Duty_{NR, x_subband}/maxDuty_{NR,x_subband}+P2×Duty_{NR, x}/maxDuty_{NR,x}. Duty_{NR, x}, Duty_{NR, x_subband} represent the actual percentage of uplink symbols transmitted and SBFD symbols with UL transmitted in the same evaluation period, wherein the exact evaluation period is no less than one radio frame, for the NR Band x and the sub-band in the NR Band x, respectively. Further, the SBFD symbols within the same evaluation period may be double counted for Duty_{NR, x_subband}. Optionally, P1 and P2 can be determined by other methods, any method in above Alternatives. For example, based on Alternative 1, P1 is a first weight for weighed average, and is the number of (SBFD symbols)/(SBFD symbols+all symbols) within the evaluation period; P2 is a second weight for weighed average, and is the number of (all symbols)/(SBFD symbols+all symbols) within the evaluation period; maxDuty_{NR,x_subband}, maxDuty_{NR,x} represent the field of UE capability maxUplinkDutyCycle-PC2-FR1 per band, and maxDuty_{NR,x_subband} is equal to maxDuty_{NR,x}. In some implementations, the maxDuty_{NR,x_subband} can be configured independently. In some implementations, P1/P2 can be determined by the percentage of frequency of UL subband and the original frequency of the BWP/carrier/band. For a non-limiting example, in FIG. 6B, when maxDuty_{NR,x_subband}=maxDuty_{NR,x}=50%. the duty cycle is calculated as: Duty Cycle=4/14×(7.14%/50%)+10/14×(21.43%/50%)=0.0408+0.3061=34.69%.

For another scheme (Scheme 3), the duty cycle may be calculated based on two evaluation periods according to various methods as described below.

For one method (Alternative 1), within an evaluation period (i.e. at least one radio frame), two sub-period are divided, one is time duration of sub-band for SBFD symbols evaluation, the rest is for legacy UL symbols transmitted evaluation. The detailed percentage can be based on adding without average (or adding with no average), equal average, or weight average.

For a non-limiting example based on addition, in FIG. 6B, the duty cycle is calculated as: Duty Cycle=(14/(14×4))+((2+28)/(14×6))=0.25+0.3571=60.71%.

For another non-limiting example based on average (or equal average), in FIG. 6B, the duty cycle is calculated as: Duty Cycle=50%×(14/(14×4))+50%×((2+28)/(14×6))=50%×(0.25+0.3571)=30.35%.

For another non-limiting example based on weighted average, in FIG. 6B, the duty cycle is calculated as: 4/10×(14/(14×4))+6/10×((2+28)/(14×6))=0.1+0.2143=31.43%.

In some implementations, the SBFD symbols within the evaluation period may be double counted for Duty_{NR, x_subband}. For a non-limiting example based on addition, in FIG. 6B, the duty cycle is calculated as: (14/(14×4×2))+((2+28)/(14×6))=0.125+0.3571=48.21%. For another non-limiting example based on average (or equal average), in FIG. 6B, the duty cycle is calculated as: 50%×(14/(14×4×2))+50%×((2+28)/(14×6))=50%×(0.125+0.3571)=24.11%. For another non-limiting example based on weighted average, in FIG. 6B, the duty cycle is calculated as: 4/10×(14/(14×4×2))+6/10×((2+28)/(14×6))=0.05+0.2143=26.43%.

For another method (Alternative 2), within an evaluation period (i.e. at least one radio frame), an additional sub-period is derived for SBFD symbols evaluation. In some implementations, the detailed percentage may be based on adding with no average or weight average. For a non-limiting example based on adding with no average, in FIG. 6B, the duty cycle is calculated as: (14/(14×4))+((2+28)/(14×10))=0.25+0.2143=46.43%. For another non-limiting example based on weighted average, in FIG. 6B, the duty cycle is calculated as: 4/10×(14/(14×4))+((2+28)/(14×10))=0.1+0.2143=31.43%.

In some implementations, the SBFD symbols within the evaluation period may be double counted for Duty_{NR, x_subband}. For a non-limiting example based on adding with no average, in FIG. 6B, the duty cycle is calculated as: (14/(14×4×2))+((2+28)/(14×10))=0.125+0.2143=33.93%. For another non-limiting example based on weighted average, in FIG. 6B, the duty cycle is calculated as: 4/10×(14/(14×4×2))+((2+28)/(14×10))=0.05+0.2143=26.43%.

In some implementations, the three schemes as discussed above may include: Scheme 1, based on single band UL transmitted on any symbols and Optimized: SBFD symbols handling; Scheme 2, based on “two bands” UL sub-band and original band are regarded as two bands with average handling, Optimized: weight average, and Optimized: SBFD symbols handling; and Scheme 3, band on single band with two periods: ne evaluation period with two non-overlapped sub-period and one evaluation period with another sub-period, Optimized: weight average, and Optimized: SBFD symbols handling.

Various embodiments described in the present disclosure may have the following benefits: different schemes of duty cycle calculation for SBFD introduced; and/or the exactly duty cycle may be derived for a carrier support SBFD which UL subband is configured within some downlink symbols. It is benefit for achieve higher efficient utilization of the maximum power of the UE to improve gNB scheduling decisions in case of SBFD introduced.

### Embodiment Set IV

The present disclosure describes various embodiments for determining statistical information, wherein virtual PHR reporting is described.

In some implementations, when the UE determines that a Type 1 power headroom report for an activated serving cell is based on a reference PUSCH transmission (virtual PHR reporting), for PUSCH transmission occasion i on active UL BWP b of carrier f of serving cell c, the UE computes the Type 1 power headroom report as

$$P {H}_{type 1 b , f , c} ( i , j , {q}_{d} , l ) = {\tilde{P}}_{CMAX , f , c} ( i ) - \{ {P}_{O \_ PUSCH , b , f , c} ( j ) + {α}_{b , f c} ( j ) \cdot {PL}_{b , f , c} ( {q}_{d} ) + {f}_{b , f , c} ( i , l ) \} [ dB ]$$

wherein \tilde{P}_{CMAX,f,c}(i) is computed assuming MPR=0 dB, A-MPR=0 dB, P-MPR=0 dB. ΔT_{C}=0 dB. MPR, A-MPR, P-MPR and ΔT_{C} are defined. The remaining parameters are defined and, if ul-powerControl is not provided, P_{O_PUSCH,b,f,c}(j) and α_{b,f,c}(j) are obtained using P_{O_NOMINAL,PUSCH,f,c}(0) and p0-PUSCH-AlphaSetId=0, PL_{b,f,c}(q_{d}) is obtained using pusch-PathlossReferenceRS-Id=0, and l=0. If ul-powerControl is provided, P_{O_PUSCH,b,f,c}(j), α_{b,f,c}(j) and l are obtained by p0-Alpha-CLID-PUSCH-Set associated with the indicated TCI-State or TCI-UL-State, PL_{b,f,c}(q_{d}) is obtained by PL-RS associated with the indicated TCI-State or TCI-UL-State.

Wherein, Type 1 power headroom is the difference between the nominal UE maximum transmit power and the estimated power for UL-SCH transmission per activated Serving Cell.

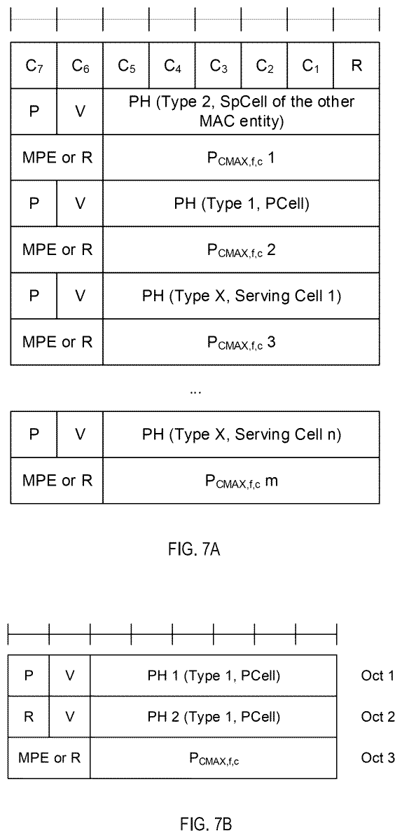

The Single Entry PHR MAC CE, it has a fixed size and consists of two octets defined as shown in FIG. 5A. The Multiple Entry PHR MAC CE, referring to FIG. 7A, it has a variable size, and includes the bitmap, a Type 2 PH field and an octet containing the associated P_{CMAX,f,c} field (if reported) for SpCell of the other MAC entity, a Type 1 PH field and an octet containing the associated P_{CMAX,f,c} field (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap. X is either 1 or 3. FIG. 7A shows a Multiple Entry PHR MAC CE with the highest ServCellIndex of Serving Cell with configured uplink is less than 8. FIG. 7B shows an enhanced Single Entry PHR for multiple TRP MAC CE.

In some implementations, there are 64 Power Headroom levels for PHR, and the power headroom reporting range is from −32 . . . +38 dB. Table 2 defines a report mapping.

TABLE 2
Power headroom report mapping

| Reported value | Measured quantity value (dB) |
|---|---|
| POWER_HEADROOM_0 | PH < −32 |
| POWER_HEADROOM_1 | −32 ≤ PH < −31 |
| POWER_HEADROOM_2 | −31 ≤ PH < −30 |
| POWER_HEADROOM_3 | −30 ≤ PH < −29 |
| . . . | . . . |
| POWER_HEADROOM_53 | 20 ≤ PH < 21 |
| POWER_HEADROOM_54 | 21 ≤ PH < 22 |
| POWER_HEADROOM_55 | 22 ≤ PH < 24 |
| POWER_HEADROOM_56 | 24 ≤ PH < 26 |
| POWER_HEADROOM_57 | 26 ≤ PH < 28 |
| POWER_HEADROOM_58 | 28 ≤ PH < 30 |
| POWER_HEADROOM_59 | 30 ≤ PH < 32 |
| POWER_HEADROOM_60 | 32 ≤ PH < 34 |
| POWER_HEADROOM_61 | 34 ≤ PH < 36 |
| POWER_HEADROOM_62 | 36 ≤ PH < 38 |
| POWER_HEADROOM_63 | PH ≥ 38 |

In some implementations, while, for virtual PHR reporting, for some cases with 1 RB reference PUSCH, the P_{O_PUSCH,b,f,c}(j) is a very small value which may lead to virtual PHR larger than 38 dB. For example, P0=100 dbm, Pathloss=80 dB, Pcmax=17 dBm, fi=0, alpha=0.8, as a result, PHR=17=(−100+0.8*80)=53 dB. This may lead to POWER_HEADROOM_63 is reported and the exactly value of PHR is not known by the gNB. This may further impact the UL power control and UL adaptive modulation and coding.

To resolve the issue, various embodiments include introducing some higher or lower level of power headroom.

For one scheme (Scheme 1), more levels are introduced. For example, 7 bits Power headroom report mapping table are defined as following Table 3.

TABLE 3
Power headroom report mapping

| Reported value | Measured quantity value (dB) |
|---|---|
| POWER_HEADROOM_0 | PH < −32 |
| POWER_HEADROOM_1 | −32 ≤ PH < −31 |
| POWER_HEADROOM_2 | −31 ≤ PH < −30 |
| POWER_HEADROOM_3 | −30 ≤ PH < −29 |
| . . . | . . . |
| POWER_HEADROOM_61 | 34 ≤ PH < 36 |
| POWER_HEADROOM_62 | 36 ≤ PH < 38 |
| POWER_HEADROOM_63 | 38 ≤ PH < 40 |
| POWER_HEADROOM_64 | 40 ≤ PH < 42 |
| POWER_HEADROOM_65 | 42 ≤ PH < 44 |
| POWER_HEADROOM_66 | 44 ≤ PH < 46 |
| . . . | . . . |
| POWER_HEADROOM_127 | reserved |

For another scheme (Scheme 2), entries of Power headroom report mapping table is not changed and some new levels are introduced. For example, 6 bits Power headroom report mapping table are defined as Table 4.

TABLE 4
Power headroom report mapping

| Reported value | Measured quantity value (dB) |
|---|---|
| POWER_HEADROOM_0 | PH < −32 |
| POWER_HEADROOM_1 | −32 ≤ PH < −31 |
| POWER_HEADROOM_2 | −31 ≤ PH < −30 |
| POWER_HEADROOM_3 | −30 ≤ PH < −29 |
| . . . | . . . |
| POWER_HEADROOM_53 | 20 ≤ PH < 22 |
| POWER_HEADROOM_54 | 22 ≤ PH < 26 |
| POWER_HEADROOM_55 | 26 ≤ PH < 30 |
| POWER_HEADROOM_56 | 30 ≤ PH < 34 |
| POWER_HEADROOM_57 | 34 ≤ PH < 38 |
| POWER_HEADROOM_58 | 38 ≤ PH < 42 |
| POWER_HEADROOM_59 | 42 ≤ PH < 46 |
| POWER_HEADROOM_60 | 46 ≤ PH < 50 |
| POWER_HEADROOM_61 | 50 ≤ PH < 54 |
| POWER_HEADROOM_62 | 54 ≤ PH < 58 |
| POWER_HEADROOM_63 | PH ≥ 58 |

For another scheme (Scheme 3), another table (Table 5) with new PH levels are introduced. For example, a second 6-bit Power headroom report mapping table are defined as following. The PHR MAC CE can be used like enhanced PHR MAC CE, wherein more than one PH fields for a Serving Cell are included. For example, PH1 is based on legacy 6 bits Power headroom report mapping table, PH2 is based on second 6 bits Power headroom report mapping table.

TABLE 5
Power headroom report mapping

| Reported value | Measured quantity value (dB) |
|---|---|
| POWER_HEADROOM_0 | 38 ≤ PH < 40 |
| POWER_HEADROOM_1 | 40 ≤ PH < 42 |
| POWER_HEADROOM_2 | 42 ≤ PH < 44 |
| POWER_HEADROOM_3 | 44 ≤ PH < 46 |
| . . . | . . . |
| POWER_HEADROOM_63 | reserved |

The present disclosure describes methods, apparatus, and computer-readable medium for wireless communication. The present disclosure addressed the issues with determining statistical information. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1-21. (canceled)

22. A method for wireless communication, the method comprising:
determining, by a user equipment (UE), a duty cycle during an evaluation period based on uplink transmission,
wherein: the uplink transmission comprises at least one of the following: uplink transmission of uplink symbols, or uplink transmission of sub-band full duplex (SBFD) symbols.

23. The method according to claim 22, wherein the determining the duty cycle during the evaluation period comprises:
determining the duty cycle based on one of the following: a percentage of uplink symbols transmitted during the evaluation period and SBFD symbols used for uplink transmission, or a percentage of symbols used for uplink transmission.

24. The method according to claim 22, further comprising:
during determining the duty cycle during the evaluation period, double counting, by the UE, SBFD symbols.

25. The method according to claim 22, further comprising:
during determining the duty cycle during the evaluation period, excluding, by the UE, SBFD symbols.

26. The method according to claim 22, further comprising:
during determining the duty cycle during the evaluation period, counting, by the UE, all SBFD symbols as uplink.

27. The method according to claim 22, wherein the determining the duty cycle during the evaluation period comprises:
determining, by the UE, the duty cycle during the evaluation period based on regarding an original band and a corresponding sub-band as two separate bands by:
averaging percentages of uplink symbols of the sub-band and an original carrier or band.

28. The method according to claim 22, wherein the determining the duty cycle during the evaluation period comprises:
determining, by the UE, the duty cycle during the evaluation period based on regarding an original band and a corresponding sub-band as two separate bands by:
weight averaging percentages of uplink symbols of the sub-band with a first weight and an original carrier or band with a second weight, wherein the sum of the first and second weights is 1.

29. The method according to claim 28, wherein:
the first weight is the SBFD symbols divided by a summation of the SBFD symbols and all symbols, and the second weight is 1 subtracted by the first weight; or
the first weight is the SBFD symbols divided by all symbols, and the second weight is 1 subtracted by the first weight.

30. The method according to claim 22, wherein the determining the duty cycle during the evaluation period comprises:
determining, by the UE, the duty cycle during the evaluation period based on a first evaluation sub-duration for the SBFD symbols and a second evaluation sub-duration for other symbols by:
adding a first percentage of SBFD symbols used for uplink transmission during the first evaluation sub-duration and a second percentage of other uplink symbols during the second evaluation sub-duration.

31. The method according to claim 30, further comprising:
averaging the first percentage of the SBFD symbols used for uplink transmission during the first evaluation sub-duration and the second percentage of the other uplink symbols during the second evaluation sub-duration, or
weight averaging the first percentage of the SBFD symbols used for during the first evaluation sub-duration and the second percentage of the other uplink symbols during the second evaluation sub-duration.

32. The method according to claim 22, wherein the determining the duty cycle during the evaluation period comprises:
determining, by the UE, the duty cycle during the evaluation period based on an evaluation period for all symbols and an evaluation sub-duration for the SBFD symbols by:
adding a first percentage of SBFD symbols used for uplink transmission during the evaluation sub-duration and a second percentage of other uplink symbols during the evaluation period.

33. The method according to claim 32, further comprising:
averaging the first percentage of the SBFD symbols used for uplink transmission during the evaluation sub-duration and the second percentage of the other uplink symbols during the evaluation period, or
weight averaging the first percentage of SBFD symbols used for uplink transmission during the evaluation sub-duration and the second percentage of the other uplink symbols during the evaluation period.

34. The method according to claim 27, further comprising:
during determining the duty cycle during the evaluation period:
double-counting the SBFD symbols,
excluding the SBFD symbols, or
counting all SBFD symbols as uplink.

35. The method according to claim 28, further comprising:
during determining the duty cycle during the evaluation period:
double-counting the SBFD symbols,
excluding the SBFD symbols, or
counting all SBFD symbols as uplink.

36. The method according to claim 30, further comprising:
during determining the duty cycle during the evaluation period:
double-counting the SBFD symbols,
excluding the SBFD symbols, or
counting all SBFD symbols as uplink.

37. The method according to claim 32, further comprising:
during determining the duty cycle during the evaluation period:
double-counting the SBFD symbols,
excluding the SBFD symbols, or
counting all SBFD symbols as uplink.

38. An apparatus comprising:
a memory storing instructions; and
at least one processor in communication with the memory, wherein, when the at least one processor executes the instructions, the at least one processor is configured to cause the apparatus to perform:
determining a duty cycle during an evaluation period based on uplink transmission,
wherein: the uplink transmission comprises at least one of the following: uplink transmission of uplink symbols, or uplink transmission of sub-band full duplex (SBFD) symbols.

39. The apparatus according to claim 38, wherein the determining the duty cycle during the evaluation period comprises:
determining the duty cycle based on one of the following: a percentage of uplink symbols transmitted during the evaluation period and SBFD symbols used for uplink transmission, or a percentage of symbols used for uplink transmission.

40. The apparatus according to claim 38, wherein, when the at least one processor executes the instructions, the at least one processor is configured to further cause the apparatus to perform:
during determining the duty cycle during the evaluation period, double counting SBFD symbols.

41. A non-transitory computer-readable medium storing instructions, wherein, the instructions, when executed by a computer, are configured to cause the computer to perform:
determining a duty cycle during an evaluation period based on uplink transmission,
wherein: the uplink transmission comprises at least one of the following: uplink transmission of uplink symbols, or uplink transmission of sub-band full duplex (SBFD) symbols.
